(19) United States
(12) Patent Application Publication
(10) Pub. No.: US 2025/0315765 A1
(43) Pub. Date: Oct. 9, 2025

(54) APPARATUSES, METHODS, SYSTEMS, AND COMPUTER STORAGE MEDIA FOR INTELLIGENTLY GENERATING POST-INCIDENT REPORTS

(71) Applicant: ATLASSIAN PTY, LTD., Sydney (AU)

(72) Inventors: Atri Mandal, Bengaluru (IN); Mayank Sawhney, Bengaluru (IN); Jason D Cruz, Melbourne (AU); Prateek Mandloi, Bengaluru (IN)

(21) Appl. No.: 19/244,659

(22) Filed: Jun. 20, 2025

Related U.S. Application Data
(63) Continuation of application No. 18/391,026, filed on Dec. 20, 2023.

(51) Int. Cl. G06Q 10/0637

(52) U.S. Cl. CPC G06Q 10/0637

(57) ABSTRACT

Methods, apparatuses, or computer-readable storage medium provide for intelligently generating post-incident reports. A post-incident indication associated with an incident may be received. Relevant post-incident data associated with the incident may be determined using one or more machine learning models and based on one or more enterprise applications. A post-incident report for the incident may be generated based on the relevant post-incident data. The post-incident report may be provided for display on a client computing device.

### CROSS-REFERENCES TO RELATED APPLICATIONS

The present application is a continuation of U.S. patent application Ser. No. 18/391,026 filed Dec. 20, 2023, which is incorporated herein by reference in its entirety.

### BACKGROUND

Incident management, particularly in a collaborative environment, may be associated with various data distributed across an enterprise platform. Applicant has identified many deficiencies and problems associated with systems that support incident management. Through applied effort, ingenuity, and innovation, these identified deficiencies and problems have been solved by developing solutions that are in accordance with the embodiments of the present invention, many examples of which are described in detail herein.

### BRIEF SUMMARY

Embodiments of the present disclosure relate to apparatuses, methods, and computer-readable storage medium for intelligently generating post-incident reports.

In accordance with one aspect, an apparatus comprising at least one processor and at least one memory including computer program code is provided. In one embodiment, the at least one memory and the computer program code may be configured to, with the at least one processor, cause the apparatus to: receive, a post-incident indication associated with an incident; determine, using one or more machine learning models and based on one or more enterprise applications, relevant post-incident data associated with the incident; generate, based on the relevant post-incident data, a post-incident report for the incident; and provide the post-incident report for display on a client computing device.

In some embodiments, the relevant post-incident data comprises one or more of fault data, corrective action data, or timeline data for the incident.

In some embodiments, generating the relevant post-incident data comprises extracting one or more incident features from incident data associated with the incident; extracting one or more alert features from alert data associated with the incident; extracting one or more communication features from communication data associated with the incident; generating, using a sequence labeling model, the corrective action data based on the one or more communication features; and generating the fault data based on one or more of (i) the one or more incident features or (ii) the one or more alert features.

In some embodiments, the sequence labeling model comprises BILSTM-CRF.

In some embodiments, generating the fault data comprises identifying, based on the alert data, one or more services associated with the incident; generating a causal graph of the one or more services; identifying, using a graph centrality model, initial fault location; and generating, using a link prediction model, a fault propagation path.

In some embodiments, generating the corrective action data comprises performing deduplication operation with respect to a first corrective action dataset extracted from the communication data based on the one or more communication features and a second corrective action dataset extracted from one or more other data sources, wherein the corrective action data comprises deduplicated corrective action data.

In some embodiments, generating the corrective action data further comprises ranking, using a learning-to-rank model and based on user input, the corrective action data.

In some embodiments, the one or more machine learning models comprise generative artificial intelligence.

In accordance with another aspect, a method for generating post-incident reports is provided. In one embodiment, the method comprises: receiving, from a client computing device, a post-incident report request associated with an incident; determining, using one or more machine learning models and based on one or more enterprise applications, relevant post-incident data associated with the incident; generating, based on the relevant post-incident data, a post-incident report for the incident; and providing the post-incident report for display on the client computing device.

In some embodiments, the relevant post-incident data comprises one or more of fault data, corrective action data, or timeline data for the incident.

In some embodiments, generating the relevant post-incident data comprises extracting one or more incident features from incident data associated with the incident; extracting one or more alert features from alert data associated with the incident; extracting one or more communication features from communication data associated with the incident; generating, using a sequence labeling model, the corrective action data based on the one or more communication features; and generating the fault data based on one or more of (i) the one or more incident features or (ii) the one or more alert features.

In some embodiments, the sequence labeling model comprises BILSTM-CRF.

In some embodiments, generating the fault data comprises identifying, based on the alert data, one or more services associated with the incident; generating a causal graph of the one or more services; identifying, using a graph centrality model, initial fault location; and generating, using a link prediction model, a fault propagation path.

In some embodiments, generating the corrective action data comprises performing deduplication operation with respect to a first corrective action dataset extracted from the communication data based on the one or more communication features and a second corrective action dataset extracted from one or more other data sources, wherein the corrective action data comprises deduplicated corrective action data.

In some embodiments, generating the corrective action data further comprises ranking, using a learning-to-rank model and based on user input, the corrective action data.

In some embodiments, the one or more machine learning models comprise generative artificial intelligence.

In accordance with another aspect, at least one non-transitory computer-readable storage medium for generating post-incident reports is provided, the at least one non-transitory computer-readable storage medium having computer coded instructions configured to, when executed by at least one processor: receive, a post-incident indication associated with an incident; determine if the incident satisfies post-incident report generation criteria; in response to determining that the incident satisfies the post-incident report generation criteria: determine, using one or more machine learning models and based on one or more enterprise applications, relevant post-incident data associated with the incident; generate, based on the relevant post-incident data, a post-incident report for the incident; and provide the post-incident report for display on a client computing device.

In some embodiments, the relevant post-incident data comprises one or more of fault data, corrective action data, or timeline data for the incident.

In some embodiments, generating the relevant post-incident data comprises extracting one or more incident features from incident data associated with the incident; extracting one or more alert features from alert data associated with the incident; extracting one or more communication features from communication data associated with the incident; generating, using a sequence labeling model, the corrective action data based on the one or more communication features; and generating the fault data based on one or more of (i) the one or more incident features or (ii) the one or more alert features.

In some embodiments, the sequence labeling model comprises BILSTM-CRF.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example post-incident report generation server system architecture within which at least some embodiments of the present invention may operate.

FIG. 2 is a block diagram of an example post-incident report generation server computing device structured in accordance with at least some embodiments of the present invention.

FIG. 3 is a block diagram of an example client computing device structured in accordance with at least some embodiments of the present invention.

FIG. 4 illustrates a visualization of an example data environment for generating a post-incident report in accordance with at least some embodiments of the present invention.

FIG. 5 is a flow chart diagram of an example process for generating a post-incident report in accordance with at least some embodiments of the present invention.

FIG. 6 is a flow chart diagram of an example process for generating relevant post-incident report data in accordance with at least some embodiments of the present invention.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present invention address technical problems associated with incident management; particularly generating incident reports in a collaborative environment after occurrence of an incident. An incident may describe an event that caused disruption to and/or a reduction in the quality of service, and which requires a response (e.g., emergency response). It is often beneficial to generate a post-incident report after an incident to document the incident, the cause(s), the corrective actions taken, and/or other activities associated with the incident. For example, a post-incident report for a particular incident may provide details of the incident (e.g., what happened, what impact the incident had, what actions were taken to resolve the incident, how a team associated with the incident can prevent the incident from happening again, and/or the like) and can enable the team uncover vulnerabilities, stop repeat incidents, decrease time to incident resolution in the future, and inform how the team handles future incidents.

A substantial amount of data may be associated with an incident and these data may distributed across various data sources. Indeed, an enterprise may utilize various applications/tools (e.g., Jira service management, Opsgenie, Bitbucket, Confluence, and/or the like) to support various functionalities, including incident management. These applications/tools may generate, store and/or maintain various data associated with an incident including, for example, alert data associated with the incident, summary of the incident, timeline of the incident, and/or other incident data. In many examples, only a portion of the substantial amount of data associated with an incident may be relevant for inclusion in a post-incident report for the incident. In this regard, it can be time-consuming, computationally expensive, cumbersome, inefficient, and error-prone for a user (e.g., alert manager, team member, and/or the like) to manually navigate the various applications/tools to access the relevant data associated with the incident.

Various embodiments of the present disclosure are directed to a post-incident report generation server system that is configured to intelligently, efficiently, and reliably generate post-incident reports for incidents after occurrence of such incidents. The below disclosed system is configured to determine and extract relevant data from a plurality of data sources using artificial intelligence framework (e.g., including one or more machine learning models), automatically generate a post-incident report such that the post-incident report includes relevant and accurate data that may be leveraged by a team and/or enterprise as a whole for various purposes.

Post-incident report generation server systems configured as disclosed herein produce a number of technical benefits. For example, by using an artificial intelligence framework to determine and extract relevant data for inclusion in a post-incident report, various embodiments of the present disclosure obviate the need for a user to navigate through multiple data sources/applications, which in turn reduces or eliminates computing resources and network traffic associated with navigating through these data sources/applications. Moreover, post-incident report generation server systems as disclosed herein are configured to render a low-latency post-incident report for a user and any enterprise applications immediately after completion of the incident (e.g., after resolution of the incident).

The disclosed system is further configured to reduce the computational expense needed to get a user up to speed on an incident and/or leverage relevant data associated with an incident on both of the client and back-end server sides. On the client side, the client computing device need only fetch and render relevant data associated with an incident and not data stored/maintained across several applications/tools. On the back-end server side, the back-end server can deliver relevant data associated with an incident rather than supporting a substantial amount of data (e.g., including irrelevant data) for access by a user as they attempt to get up to speed on an incident or leverage data associated with an incident for improvement and/or other purposes.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” refers to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “post-incident indication” refers to signal, data, and/or computer readable instructions received that triggers a post-incident report generation process. For example, a post-incident report may be automatically generated for an incident in response to a post-incident indication. In some embodiments, a post-incident indication may be generated by an enterprise application. Alternatively or additionally, in some embodiments, a post-incident indication may be generated by a post-incident report generation server system configured to generate post-incident reports. In some embodiments, a post-incident indication may be generated after resolution of an incident. For example, a post-incident indication may be associated with a final stage of an incident management process.

The term “post-incident report request” refers to signal, data, and/or computer readable instructions received by one or more computing devices (e.g., post-incident report generation server computing device) that comprise, represents, indicates, and/or is associated with a request to generate a post-incident report for an incident. In some embodiments, a post-incident report request includes at least one incident identifier. For example, a post-incident report request may comprise an incident identifier associated with an incident and may be indicative of a request to generate a post-incident report for the incident. In some embodiments, the post-incident report request may be generated in response to user engagement with a post-incident report interface. For example, a post-incident report generation server system 101 may receive a post-incident report request originating from a client computing device associated with a user (e.g., alert manager, team member, team manager, and/or the like) in response to user engagement with the post-incident report interface.

The term “incident identifier” refers to one or more items or elements by which an incident may be uniquely identified from other incidents. The incident identifier may be in the form of text string(s), numerical character(s), alphabetical character(s), alphanumeric code(s), American Standard Code for information Interchange (ASCII) characters(s), and/or the like.

The term “enterprise application” refers to an application that is accessible to one or more client computing devices, and that is operable to provide access to one or more services. An enterprise application may generate, store and/or maintain various data (e.g., incident data, alert data, and/or the like). In some examples, an enterprise application may comprise one or more computing devices (e.g., server computing device, cloud computing device, and/or the like) running a software application having access to one or more databases storing digital content, application-related data, and/or the like. An enterprise application may be configured to communicate with one or more other enterprise applications associated with an enterprise. In some examples, a cloud computing network may host one or more enterprise applications. In some examples, a post-incident report generation server system may access data generated, stored, and/or maintained by an enterprise application to generate post-incident reports. In some examples, the post-incident report generation server system may transmit post-incident reports to an enterprise application. Non-limiting examples of an enterprise application include Jira service management, Opsgenie, Bitbucket, Confluence, Slack, Microsoft Teams, and/or the like.

The term “post-incident report” refers to a data structure comprising a collection of relevant post-incident data associated with an incident. In some embodiments, a post-incident report generation server system may leverage one or more machine learning models to generate a post-incident report. A post-incident report for a particular incident may provide details of the incident (e.g., what happened, what impact it had, what actions were taken to resolve the incident, how a team associated with the incident can prevent re-occurrence of the incident, and/or the like). In some examples, a post-incident report can enable a team associated with the incident uncover vulnerabilities, stop repeat incidents, decrease time to incident resolution in the future, and/or inform how the team handles future incidents.

The term “relevant post-incident data” refers to data deemed relevant for inclusion in a post-incident report. Examples of relevant post-incident data include fault location (e.g., location of a fault associated with an incident), blast radius for the incident, corrective action implemented, and/or the like. In some embodiments, the post-incident report generation server system is configured to correlate various data (e.g., incident data, alert data, and/or the like) generated, stored, and/or maintained by one or more enterprise applications to determine relevant post-incident data. In some embodiments, a post-incident report generation server system leverages one or more techniques and/or one or more machine learning models to determine relevant post-incident data associated with an incident. In some embodiments, the one or more machine learning models include one or more natural language processing (NLP) models. Alternatively or additionally, in some embodiments, the one or more machine learning models include one or more of a Bi-directional-Long-Short Term Memory-Conditional Random Field (BiLSTM-CRF), LSTM models, hidden Markov models, learning-to-rank models, and/or the like. In some embodiments, a post-incident report generation server system may leverage a causal inference technique to generate inferences and correlate the inferences with topology information to determine one or more portions of the relevant post-incident data for an incident. In some embodiments, the post-incident report generation server system leverages a machine learning model to generate one or more portions of the relevant post-incident data for an incident based on a causal inference technique, BILSTM-CRF sequence labeling technique, and/or the like.

The term “post-incident report storage location” refers to a location, such as a database/repository stored on a memory device, which is accessible by one or more computing devices for retrieval and storage of post-incident reports and/or data associated with generating post-incident reports. In some embodiments, the post-incident report storage location may be a dedicated device and/or a part of a larger repository. In some embodiments, the post-incident report storage location may comprise post-incident reports of selected incidents associated with incident identifiers that satisfy post-incident report generation criteria.

The term “post-incident report generation criteria” refers to a data element that is leveraged by a post-incident report generation server system to determine whether to generate a post-incident report for an incident in response to a post-incident indication and/or post-incident report request associated with the incident. In some embodiments, the post-incident report generation criteria comprise a severity level threshold. In such some embodiments, a post-incident report may be generated for an incident report in response to determining that the incident identifier associated with the post-incident indication and/or post incident report request satisfies the severity level threshold.

The term “post-incident report interface” refers to a user interface rendered to a client computing device for displaying post-incident reports. In some embodiments, the post-incident report user interface may be rendered to a client computing device associated with a user to enable the user to generate a post-incident report request for an incident. In some embodiments, a post-incident report generation server system generates the post-incident report interface. In some embodiments, the post-incident report interface may be sub-user interface that is specially configured to enable user to generate a post-incident report request and/or to view post-incident reports. In some embodiments, the post-incident report interface includes one or more user interface elements for inputting (e.g., by a user) one or more post-incident report request parameters (e.g., incident identifier, team information, date, and/or the like).

The term “communication channel” refers to an electronic communication medium configured for providing collaborative capabilities that enable a plurality of client computing devices to transmit, display, receive, access, and/or engage with communication data generated by the plurality of client computing devices, wherein each client computing device of the plurality of client computing devices may be associated with a member identifier. A communication channel may be created, generated, initiated, and/or the like via an application configured to provide chat services (e.g., iMessage, Google Messages, Slack, MS Teams, WhatsApp, and/or the like). For example, one or more communication channels may be generated via Slack, MS Teams, and/or the like to provide a platform for software developers and/or other users to communicate in response to an incident alert generated by an integrated collaboration application configured to provide incident management services. The communication channels, for example, may be leveraged to facilitate resolution of an incident associated with the incident alert. In some examples, multiple communication channels may be generated to address the incident, where each communication channel may focus on a different task and/or aspect with respect to the incident, and/or may be associated with a topic, a workstream, a corrective action, and/or the like with respect to the incident.

The term “communication data” refers to a data entity that describes content data (e.g., text or other media) of a communication channel. In various embodiments, communication data comprise a message transmitted, posted, and/or otherwise shared among and/or within a group via a communication channel. Communication data and/or a portion of communication data may be capable of being transmitted, received, and/or stored in accordance with embodiments of the present invention. Communication data and/or a portion of communication data may be sent and received between multiple computers, multiple servers, and may pass through multiple relays, routers, network access points, base stations, hosts, and/or the like, which is sometimes referred to as a “network.” Communication data may include various data associated with an incident. By way of example, communication data may include corrective action data (e.g., text data that describes one or more corrective actions mentioned and/or discussed within a communication channel).

The term “incident” refers to a data entity that describes an event that causes disruption to or a reduction in the quality of a service associated with a software application, a service, a software application feature, a network, and/or a device. In one example, an incident associated with a monitored software application may require an emergency response. In some embodiments, an incident is created based on alert data associated with one or more alerts and/or conditions for creating an incident. In some examples, an incident may be automatically created in response to the number of alerts associated with a particular service exceeding a threshold associated with a parameter/keyword for a period of time.

In some embodiments, an incident may be more simply associated with one or more alerts. An alert may be associated or otherwise linked to a particular incident if the alert data satisfies one or more incident rules with respect to the particular incident. In some embodiments, one or more issue data objects (e.g., problem tickets) may be associated with an incident. For example, one or more issue data objects (e.g., problem tickets) issued (e.g., by an IT service desk) may be associated with a particular incident. In some examples, an incident may be automatically created in response to the number of issue data objects (e.g., problem tickets) associated with a particular service exceeding a threshold associated with a parameter/keyword for a period of time.

The term “incident data” refers to a data entity that describes data associated with an incident. Incident data may comprise text data such as incident title, incident description, incident comments, and/or other text data and/or media associated with the incident. In some embodiments, incident data may be leveraged to identify relevant post-incident data as described herein.

The term “alert” refers to a data entity configured to convey information about an event or occurrence that warrants attention. In some examples, an alert may be configured to provide warnings of abnormal activity associated with a service. In some examples, alerts may be generated by monitoring tools. An alert, for example, may be created and transmitted to one or more users (e.g., a service administrator, service manager, team member, and/or the like) in response to satisfaction of one or more rules and/or conditions. For example, a user may define a set of rules and/or conditions, wherein an alert may be generated and transmitted to one or more users upon the occurrence of such rules and/or conditions. In some examples, an alert may comprise or otherwise may be received via email, phone call, SMS, mobile push, and/or the like. An alert may include information (e.g., alert data) about an event such as a fault with a service.

The term “alert data” refers to a data entity that describes data associated with an alert. Alert data may comprise information about an event. In some examples alert data may comprise text such date, time, alert message, service identifier, number of problem tickets associated with various issues associated with a service, and/or the like.

Thus, use of any such terms, as defined herein, should not be taken to limit the spirit and scope of embodiments of the present disclosure.

### Example System Architecture

Methods, apparatuses, systems, and computer storage media of the present disclosure may be embodied by any of a variety of devices. For example, the method, apparatus, systems, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

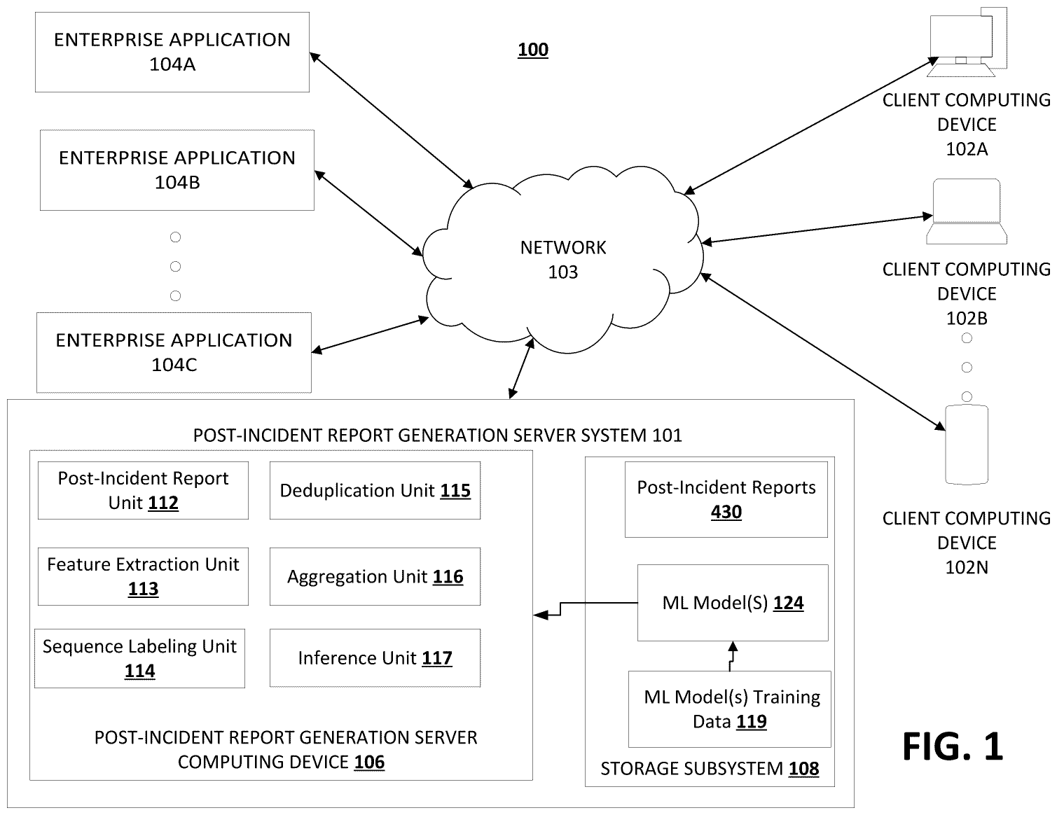

FIG. 1 depicts an example post-incident report generation server system architecture 100 for intelligently generating post-incident reports and providing the post-incident reports for display on one or more client computing devices. The post-incident report may include a plurality of segments that collectively define the post-incident report. In some embodiments, the post-incident report includes at least a timeline segment, a root cause segment, and a corrective action segment. The post-incident report generation server system architecture 100 includes one or more client computing devices 102A-N, one or more enterprise applications 104A-N, and a post-incident report generation server system 101.

In some embodiments, the one or more enterprise applications 104A-N are associated with an enterprise platform. For example, an enterprise may leverage one or more enterprise applications. In some embodiments, an enterprise application is an application that is accessible to one or more client computing devices, and that is operable to provide access to one or more services/tools (e.g., project management services, incident management services, document management services, and/or the like). Non-limiting examples of an enterprise application include Jira service management, Opsgenie, Bitbucket, Confluence, Slack, Microsoft Teams, and/or the like. An enterprise application may generate, store and/or maintain various data (e.g., incident data, alert data, and/or the like). In some examples, an enterprise application may comprise one or more computing devices (e.g., server computing device, cloud computing device, and/or the like) running a software application having access to one or more databases storing digital content, application-related data, and/or the like. An enterprise application may be configured to communicate with one or more other enterprise applications associated with an enterprise. In some examples, a cloud computing network may host one or more enterprise applications. In some embodiments, the post-incident report generation server system 101 may access data generated, stored, and/or maintained by the one or more enterprise applications 104A-N to generate post-incident reports. In some embodiments an enterprise application may receive a generated post-incident report from the post-incident report generation server system 101 for display on one or more client computing devices.

In some embodiments, the post-incident report generation server system 101 is configured to generate post-incident reports for incident identifiers in response to a post-incident indication and provide the post-incident reports to one or more client computing devices and/or enterprise application. The post-incident report generation server system 101 may store the post-incident reports in a post-incident report storage location. Additionally and/or alternatively, the post-incident report generation server system 101 may be configured to receive a post-incident report request (e.g., from a client computing device) associated with an incident identifier, generate post-incident report(s) for the incident identifier in response to the post-indent report request, and provide the post-incident report(s) to one or more client computing devices and/or enterprise applications. The post-incident report generation server system 101 may be configured to intelligently generate a post-incident report using an artificial intelligence framework. In some embodiments, the artificial intelligence framework comprises generative artificial intelligence. For example, the post-incident report generation server system 101 may be configured to generate post-incident reports using one or more generative artificial intelligence techniques. By way of example, such generative artificial intelligence techniques may include OpenAI APIs, Open-Source Large Language Models (open source LLMs), and/or the like. The post-incident report generation server system 101 may leverage one or more machine learning models to perform various functionalities associated with intelligently generating a post-incident report including, for example, determining relevant post-incident data, correlating data from various data sources, and/or the like.

The post-incident report generation server system 101 may include a post-incident report generation server computing device 106 and a storage subsystem 108. The post-incident report generation server computing device 106 may be configured to receive or otherwise identify post-incident indications and/or post-incident report requests (e.g., from a client computing device), as well as provide post-incident reports for display on the client computing devices in response to the post-incident indications and/or post-incident report requests. The post-incident report generation server computing device 106 may be configured to utilize one or more machine learning models 124 to generate the post-incident reports and/or facilitate performance of various functionalities associated with generating the post-incident reports.

In some embodiments, the post-incident report generation server system 101 comprises a post-incident report unit 112, a feature extraction unit 113, a sequence labeling unit 114, a deduplication unit 115, an aggregation unit 116, and an inference unit 117. Each of the post-incident report unit 112, the feature extraction unit 113, the sequence labeling unit 114, the deduplication unit 115, the aggregation unit 116, and/or the inference unit 117 may be any means such as a device or circuitry embodied in either hardware, software, or a combination of hardware and software.

The post-incident report unit 112 may be configured to orchestrate various functionalities associated with automatically and intelligently generating a post-incident report as described herein, including identifying and extracting relevant post-incident data to include in the post-incident report or otherwise to utilize in generating a post-incident report. The post-incident report unit 112 may transmit data, signals, and/or the like to the feature extraction unit 113, the sequence labeling unit 114, the deduplication unit 115, the aggregation unit 116, the inference unit 117, and/or the post-incident report unit 112 to facilitate performance of various functionalities associated with automatically and intelligently generating a post-incident report as described herein. Alternatively or additionally, the post-incident report unit 112 may receive data, signals, and/or the like from the feature extraction unit 113, the sequence labeling unit 114, the deduplication unit 115, the aggregation unit 116, the inference unit 117, and/or the post-incident report unit 112 to facilitate performance of various functionalities associated with automatically and intelligently generating a post-incident report as described herein. The post-incident report unit 112 may be configured to receive and/or identify post-incident indications and/or post-incident report requests, and initiate generation of a post-incident report in response to a post-incident indication and/or post-incident report request. The post-incident report unit 112 may identify an incident identifier associated with a post-incident indication and/or post-incident report request. The post-incident report unit 112 may transmit a signal, computer readable instructions, and/or the like to the feature extraction unit 113 configured to cause the feature extraction unit 113 to perform various functionalities associated with the feature extraction unit 113.

The feature extraction unit 113 may interact with one or more enterprise applications 104A-N to extract data features from data generated and/or maintained via the one or more enterprise applications 104A-N. The feature extraction unit 113 may be configured to extract one or more incident features from incident data and/or issue data associated with the incident, extract one or more alert features from alert data associated with the incident, and/or extract one or more communication features from communication data associated with the incident. In some embodiments, extracting the one or more incident features from the incident data may comprise transforming the incident data (or a portion thereof) into numerical features, such as a n-dimensional vector representation, which may be leveraged by a machine learning model to perform one or more tasks. In some embodiments, extracting the one or more alert features from the alert data may comprise transforming the alert data (or a portion thereof) into numerical features, such as a n-dimensional vector representation, which may be leveraged by a machine learning model to perform one or more tasks. In some embodiments, extracting the one or more communication features may comprise transforming the communication data (or a portion thereof) into numerical features, such as a n-dimensional vector representation, which may be leveraged by a machine learning model to perform one or more tasks. In some embodiments, the feature extraction unit 113 leverages one or more of a variety of feature extraction techniques (e.g., term frequency-inverse document frequency (TF-IDF), bag of words, or the like) to extract the one or more incident features, one or more alert features, and/or one or more communication features. The feature extraction unit 113 may be configured to transmit one or more of the incident features, alert features, or communication features to the post-incident report unit 112 and/or one or more other units of the post-incident report generation server system 101.

In some embodiments, the feature extraction unit 113 transmits the one or more incident features extracted from the incident data and the alert features extracted from the alert data to at least the post-incident report unit 112. The post-incident report unit 112 may be configured to leverage one or more models to generate an incident summary based on the one or more incident features. The one or more models may include one or more machine learning models. In some embodiments, the one or more models includes generative artificial intelligence such as, for example, OPenAI API, LLM API, and/or the like.

The sequence labeling unit 114 may utilize one or more models to perform and/or facilitate various functionalities associated with generating a post-incident report. The one or more models may include one or more machine learning models. In some embodiments, the sequence labeling unit 114 leverages a sequence labeling model to identify and extract corrective action data from communication data based on communication features received from the feature extraction unit 113. For example, the sequence labeling unit 114, utilizing a sequence labeling model, may identify and extract corrective action data items (e.g., corrective action phrases) embedded within communication data. The sequence labeling model may receive the communication features as input and process the communication features to output corrective action data comprising one or more corrective action data items (e.g., corrective action phrases). For example, the sequence labeling model may be leveraged to identify and extract relevant actions from communication data based on the communication features. In some embodiments, the sequence labeling model comprises a trained BILSTM-CRF model. In some embodiments, the BILSTM-CRF model is trained with labeled sequences using BIO encoding. In some embodiments, the sequence labeling unit 114 leverages a sentence parser to identify and/or extract the relevant actions. A non-limiting example of a parser that may be leveraged by the sequence labeling unit 114 includes an English Slot Grammar (ESG) parser.

The deduplication unit 115 may be configured to deduplicate corrective action data from one or more data sources. In some embodiments, the deduplication unit 115 is configured to deduplicate corrective action data items (e.g., corrective action phrases) extracted from communication data and corrective action data items extracted from incident data. By way of example, a first corrective action data item extracted from communication data may be the same as a second corrective action data item extracted from incident data. In such example, the deduplication unit 115 may be configured to deduplicate the first corrective action data and the second corrective action data. The deduplication unit 115 may receive the corrective action data extracted from the communication data from the sequence labeling unit 114. For example, the deduplication unit 115 may receive output of the sequence labeling model (e.g., BILSTM-CRF in some embodiments) as input, and process the corrective action data (e.g., corrective action data items thereof) alone and/or with corrective action data from other data sources (e.g., from incident data) to deduplicate the corrective action data.

The aggregation unit 116 may be configured to aggregate corrective action data identified and extracted from various data sources. In some embodiments, the aggregation unit 116 may be configured to rank the corrective actions data. The aggregation unit 116, for example, may generate a list of individual corrective action data items arranged in an order of based on the rank value for each corrective action data item by the aggregation unit 116. The aggregation unit 116 may leverage one or more models to rank the corrective action data. In some embodiments, the aggregation unit 116 leverages a learning-to-rank model to rank the corrective action data based on user input (e.g., customer feedback).

The inference unit 117 may be configured to execute or cause execution of one or more inference operations based on the incident data and/or alert data. In some embodiments, the output of the one or more inference operations comprises a root cause of the incident, fault location, and/or fault propagation path. In some embodiments, a fault location describes the faulty service associated with the incident. In some embodiments, the inference unit 117 leverages a graph centrality-based technique to identify the fault location for the incident based on incident features extracted from incident data and/or alert features extracted from alert data. The inference unit 117 may be configured to receive the alert features and/or incident features from the feature extraction unit 113. The inference unit 117 may leverage topology data (e.g., CMDB, causal graph, and/or the like) to identify the fault location. Additionally, in some embodiments, the inference unit 117 may leverage graph centrality-based technique to determine the blast radius for the incident. The inference unit 117 may be configured to generate a fault propagation path (e.g., inferred fault propagation path).

In some embodiments, the inference unit 117 is configured to execute or cause execution of one or more inference operations to output a root cause of the faulty service that triggered the incident. Additionally, in some embodiments, the inference unit 117 is configured to execute or cause execution of one or more inference operations to output a root cause for incident-related services. Incident-related services as used herein may describe other services affected by the incident (e.g., triggered by the faulty service).

The post-incident report generation server system 101 may be configured to leverage generative artificial intelligence to generate a post-incident report based on the incident summary, fault location, timeline, and corrective actions. The post-incident report unit 112 may be configured to transmit a post-incident report to one or more client computing devices 102A-N and/or enterprise applications. In some embodiments, the post-incident report unit 112 may render the post-incident report on a post-incident report interface. In some embodiments, the post-incident report unit 112 is configured to automatically transmit a post-incident report to one or more client computing devices and/or enterprise applications. Alternatively or additionally, the post-incident report unit 112 may be configured to transmit a post-incident report to a client computing device or enterprise application in response to a user request.

In some embodiments, the storage subsystem 108 is configured to store data associated with the post-incident report generation server computing device 106, such as, for example, training data 119 for the one or more machine learning models 124. In some embodiments, the storage subsystem 108 comprises the one or more post-incident report storage locations. In this regard, the storage subsystem 108 may be configured to store post-incident reports.

The client computing devices 102A-N, enterprise applications 104A-N (e.g., host server for an enterprise application) and the post-incident report generation server computing device 106 may communicate over one or more networks 103. A network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, a network may include a cellular telephone, an 802.11, 802.16, 802.20, and/or WiMax network. Further, a network may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the page management system. In some embodiments, the protocol is a custom protocol of JavaScript Object Notation (JSON) objects sent via a WebSocket channel. In some embodiments, the protocol is JSON over RPC, JSON over REST/HTTP, and the like.

### Example Post-Incident Report Generation Server Computing Device

The post-incident report generation server computing device 106 may include circuitry, networked processors, or the like configured to perform some or all of the post-incident report generation server-based processes described herein and may be any suitable network server and/or other type of processing device. In some embodiments, post-incident report generation server computing device 106 may determine and transmit commands and instructions for generating a post-incident report for an incident in response to a post-incident indication and/or post-incident report request. The post-incident report generation server computing device 106 may be embodied by any of a variety of devices, for example, the post-incident report generation server computing device 106 may be embodied as a computer or a plurality of computers. For example, the post-incident report generation server computing device 106 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals.

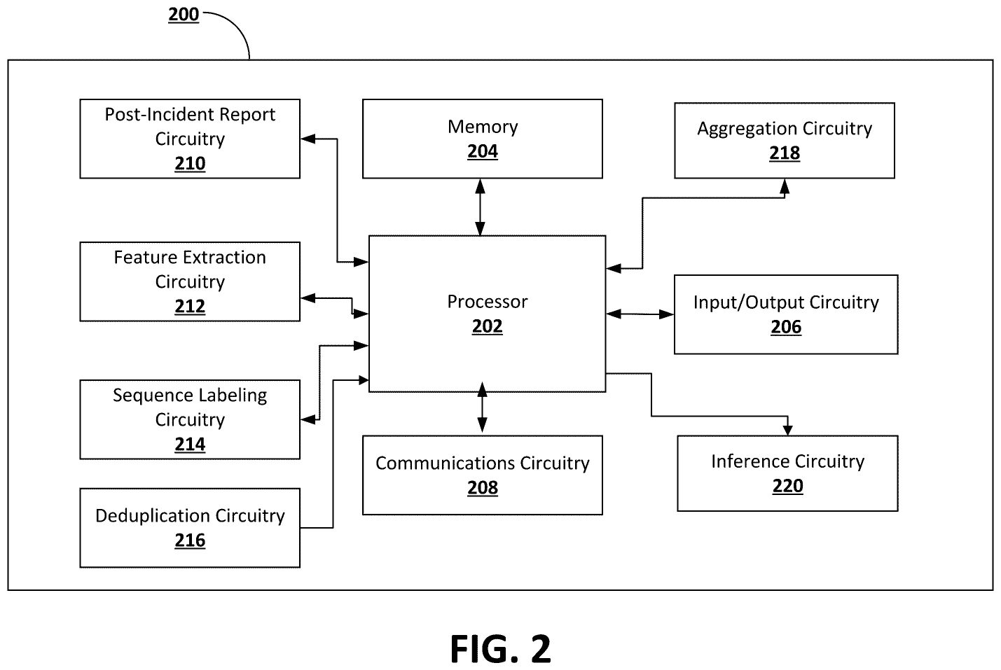

The post-incident report generation server computing device 106 may be embodied by one or more computing systems, such as apparatus 200 shown in FIG. 2. The apparatus 200 may include processor 202, memory 204, input/output circuitry 206, and communications circuitry 208, post-incident report circuitry 210, feature extraction circuitry 212, sequence labeling circuitry 214, deduplication circuitry 216, aggregation circuitry 218, and/or inference circuitry 220. The apparatus 200 may be configured to execute the operations described herein. Although these components 202-220 are described with respect to functional limitations, it should be understood that the particular implementations necessarily include the use of particular hardware. It should also be understood that certain of these components 202-220 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus includes a post-incident report circuitry 210. The post-incident report circuitry 210 includes any means such as device or circuitry embodied in either hardware or a combination of hardware and software that is configured to perform various functionalities associated with generating a post-incident report as described herein. In some embodiments, the post-incident report is configured to extract data features from one or more data sources. In some embodiments, the post-incident report circuitry 210 is configured to transmit to and/or receive data, signals, and/or the like from other circuitry, components, and/or the like associated with the apparatus to facilitate performance of various functionalities associated with automatically and intelligently generating a post-incident report as described herein. In some embodiments. In some embodiments, the post-incident report circuitry 210 is configured to generate, based on relevant post-incident report data (e.g., the incident summary data, fault data, root cause data, timeline data, corrective action data, and/or the like) and utilizing one or more machine learning models (e.g., generative AI, natural language processing models, and/or the like), a post-incident report. The post-incident report circuitry 210 may be configured to transmit a post-incident report to one or more client computing devices 102A-N and/or enterprise applications.

In some embodiments, the apparatus includes feature extraction circuitry 212. The feature extraction circuitry 212 includes any means such as device or circuitry embodied in either hardware or a combination of hardware and software that is configured to perform various functionalities associated with generating a post-incident report as described herein. In some embodiments, the feature extraction circuitry 212 is configured to extract data features from data generated and/or maintained via the one or more enterprise applications 104A-N. The feature extraction circuitry 212 may be configured to extract one or more incident features from incident data and/or issue data associated with the incident, extract one or more alert features from alert data associated with the incident, and/or extract one or more communication features from communication data associated with the incident.

In some embodiments, the apparatus includes sequence labeling circuitry 214. The sequence labeling circuitry 214 includes any means such as device or circuitry embodied in either hardware or a combination of hardware and software that is configured to perform various functionalities associated with generating a post-incident report as described herein. The sequence labeling circuitry 214 may utilize one or more models to perform and/or facilitate various functionalities associated with generating a post-incident report. The sequence labeling circuitry 214 may be configured to receive communication features as and process the communication features, using a sequence labeling model, to output corrective action data.

In some embodiments, the apparatus includes deduplication circuitry 216. The deduplication circuitry 216 includes any means such as device or circuitry embodied in either hardware or a combination of hardware and software that is configured to perform various functionalities associated with generating a post-incident report as described herein. In some embodiments, the deduplication circuitry 216 may be configured to deduplicate corrective action data extracted from communication data and/or corrective action data extracted from incident data.

In some embodiments, the apparatus includes aggregation circuitry 218. The aggregation circuitry 218 includes any means such as device or circuitry embodied in either hardware or a combination of hardware and software that is configured to perform various functionalities associated with generating a post-incident report as described herein. In some embodiments, the aggregation circuitry 218 may be configured to aggregate corrective action data identified and extracted from various data sources. In some embodiments, the aggregation circuitry 218 may be configured to rank the corrective actions data.

In some embodiments, the apparatus includes inference circuitry 220. The inference circuitry 220 includes any means such as device or circuitry embodied in either hardware or a combination of hardware and software that is configured to perform various functionalities associated with generating a post-incident report as described herein. In some embodiments, the inference circuitry 220 may be configured to execute or cause execution of one or more inference operations based on the incident data and/or alert data. In some embodiments, the inference circuitry 220 is configured to utilize a graph centrality-based technique to identify the fault location for the incident based on incident features extracted from incident data and/or alert features extracted from alert data. In some embodiments, the inference circuitry 220 is configured to utilize topology data (e.g., CMDB, causal graph, and/or the like) to identify the fault location. In some embodiments, the inference circuitry 220 is configured to utilize graph centrality-based technique to determine the blast radius for an incident. In some embodiments, the inference circuitry 220 is configured to generate a fault propagation path. In some embodiments, the inference circuitry 220 is configured to execute or cause execution of one or more inference operations to output a root cause of the faulty service that triggered the incident. Additionally, in some embodiments, the inference circuitry 220 is configured to execute or cause execution of one or more inference operations to output a root cause for incident-related services.

Additionally or alternatively, in some embodiments, two or more of the sets of circuitries embodying processor 202, memory 204, input/output circuitry 206, communications circuitry 208, post-incident report circuitry 210, feature extraction circuitry 212, sequence labeling circuitry 214, deduplication circuitry 216, aggregation circuitry 218, and/or inference circuitry 220 are combinable. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, post-incident report circuitry 210, feature extraction circuitry 212, sequence labeling circuitry 214, deduplication circuitry 216, aggregation circuitry 218, and/or inference circuitry 220 are combined into a single module embodied in hardware, software, firmware, and/or a combination thereof. Similarly, in some embodiments, one or more of the sets of circuitry, for example, post-incident report circuitry 210, feature extraction circuitry 212, sequence labeling circuitry 214, deduplication circuitry 216, aggregation circuitry 218, and/or inference circuitry 220 is/are combined with the processor 202, such that the processor 202 performs one or more of the operations described above with respect to each of these sets of circuitry embodied by the post-incident report circuitry 210, feature extraction circuitry 212, sequence labeling circuitry 214, deduplication circuitry 216, aggregation circuitry 218, and/or inference circuitry 220.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

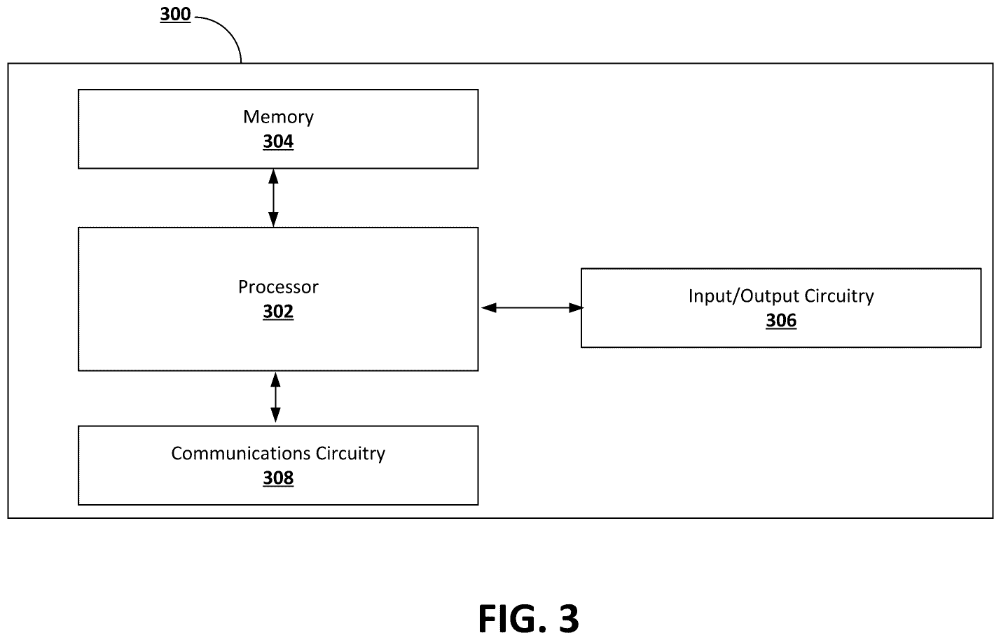

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Exemplary Data Flows and Operations

Various embodiments of the present invention are directed to a post-incident report generation server system that is configured to efficiently and intelligently generate post-incident report(s) after an incident to, for example, document the incident; cause(s) of the incident; corrective actions taken and/or other activities associated with the incident. Various embodiments of the present invention provide the post-incident reports to one or more client computing devices for display on the one or more client computing devices. The below disclosed system is configured to execute a post-incident report generation process. In some embodiments, the post-incident report generation process comprises identifying enterprise applications and/or associated data sources storing data associated with an incident, identifying relevant post-incident data to include in a post-incident report for the incident or otherwise to utilize in generating a post-incident report for the incident, extracting the relevant post-incident data, generating a post-incident report for the incident based on the relevant post-incident data, and/or presenting the post-incident report to one or more users via client computing device(s) associated with the one or more users (e.g., by rendering the post-incident report for display on the client computing device(s)).

In some embodiments, the disclosed system is configured to execute the post-incident report generation process in response to a post-incident indication. In some embodiments, a post-incident indication is a signal, data, and/or computer readable instructions that triggers a post-incident report generation process as described herein. For example, a post-incident report may be automatically generated for an incident in response to a post-incident indication. In some embodiments, a post-incident indication may be generated by an enterprise application. Alternatively or additionally, in some embodiments, a post-incident indication may be generated by a post-incident report generation server system 101. In some embodiments, a post-incident indication may be generated after resolution of an incident. For example, a post-incident indication may be associated with a final stage of an incident management process. For example, a post-incident indication may indicate that an incident has been resolved or otherwise indicate completion of an incident resolution process.

Alternatively or additionally, in some embodiments, the disclosed system is configured to execute the post-incident report generation process in response to a post-incident report request. In some embodiments, a post-incident report request is a signal, data, and/or computer readable instructions received by one or more computing devices (e.g., post-incident report generation server computing device) that comprise, represents, indicates, and/or is associated with a request to generate a post-incident report for an incident. In some embodiments, a post-incident report request includes at least one incident identifier. For example, a post-incident report request may comprise an incident identifier associated with an incident and may be indicative of a request to generate a post-incident report for the incident. In some embodiments, the post-incident report request may be generated in response to user engagement with a post-incident report interface. For example, a post-incident report generation server system 101 may receive a post-incident report request originating from a client computing device associated with a user (e.g., alert manager, team member, team manager, and/or the like) in response to user engagement with the post-incident report interface.

As noted above, post-incident report generation server systems configured as disclosed herein provide a number of technical benefits. For example, post-incident report generation server systems configured as disclosed herein intelligently, efficiently, and reliably generate post-incident reports for incidents after occurrence of such incidents. The disclosed system as described herein is configured to determine and extract relevant data from a plurality of data sources using artificial intelligence framework (e.g., including one or more machine learning models), automatically generate a post-incident report such that the post-incident report includes relevant and accurate data that may be leveraged by a team and/or enterprise as a whole for various purposes.

Post-incident report generation server systems configured as disclosed herein produce a number of technical benefits. For example, by using an artificial intelligence framework to determine and extract relevant data for inclusion in a post-incident report and/or to utilize in generating a post-incident report, various embodiments of the present disclosure obviate the need for a user to navigate through multiple data sources/applications, which in turn reduces or eliminates computing resources and network traffic associated with navigating through these data sources/applications. Moreover, post-incident report generation server systems as disclosed herein are configured to render a low-latency post-incident report for a user and any enterprise applications immediately after completion of the incident (e.g., after resolution of the incident). The disclose system is further configured to reduce the computational expense needed to get a user up to speed on an incident and/or leverage relevant data associated with an incident on both of the client and back-end server sides. On the client side, the client computing device need only fetch and render relevant data associated with an incident and not data stored/maintained across several applications/tools. On the back-end server side, the back-end server can deliver relevant data associated with an incident rather than supporting a substantial amount of data (e.g., including irrelevant data) for access by a user as they attempt to get up to speed on an incident or leverage data associated with an incident for improvement and/or other purposes.

### Example Data Environments and Architectures of the Disclosure

Having described example systems and apparatuses of the disclosure, example data architectures, data environments, and data flows will now be described. In some embodiments, the data architectures represent data object(s) maintained and processed in particular computing environments. In some embodiments, the computing environment(s) is/are maintained via hardware, software, firmware, and/or a combination thereof, that execute one or more software application(s) that manage such data. For example, in some embodiments, the apparatus 200 executes one or more software application(s) that maintain the data architecture(s) as depicted and described to, alone or in conjunction with one another, perform the functionality as depicted and described with respect to generating post-incident reports and transmitting the post-incident reports for display on one or more client computing devices.

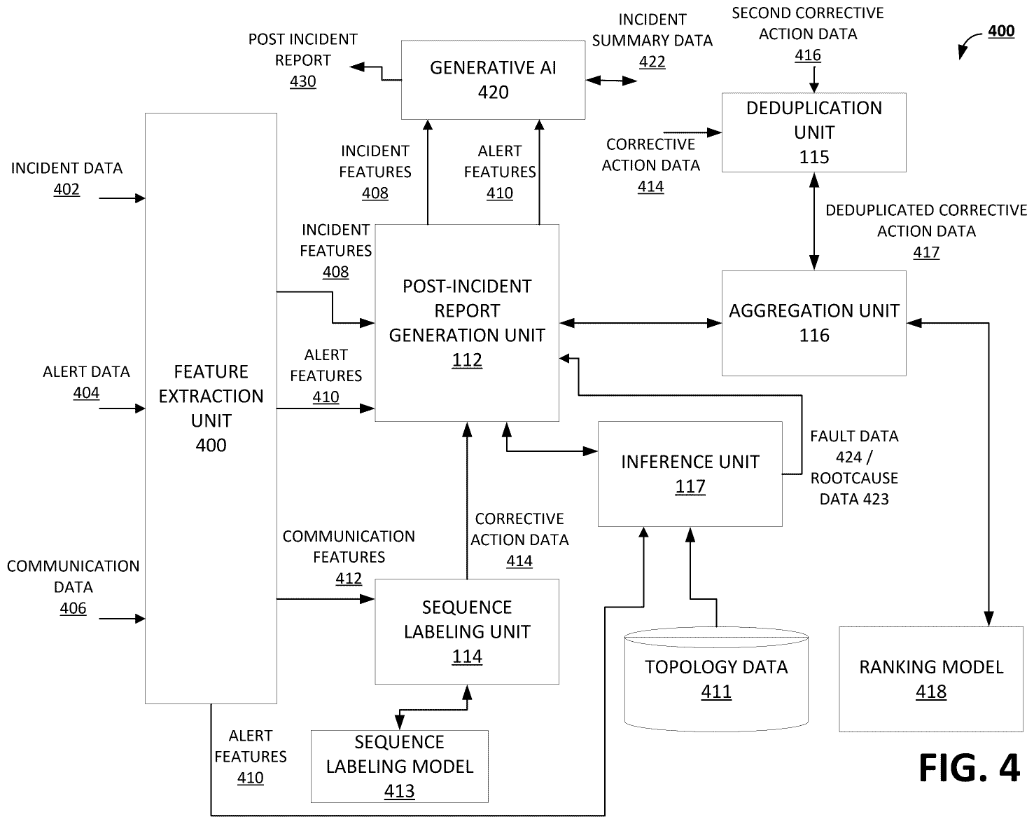

FIG. 4 illustrates a visualization of an example data environment 400 for generating a post-incident report in accordance with at least some embodiments of the present disclosure. Specifically, the data environment for generating the post-incident report is performed by a post-incident report generation server system 101. The post-incident report generation server system 101 may embody a particular implementation of the post-incident report generation server system 101 as depicted and described herein. For example, in some embodiments, the post-incident report generation server system 101 is embodied by the apparatus 200 as depicted and described herein. In some embodiments, the post-incident report generation server system 101 causes rendering of, or otherwise provides access to, one or more user interfaces specially configured to enable inputting and/or displaying of data.

A post-incident report generation process as described herein may be initiated in response to a post-incident indication. For example, the post-incident report generation server system 101 may receive a post-incident indication associated with an incident. The post-incident indication may correspond to a qualifying incident management event or otherwise generated in response to a qualifying incident management event. In some embodiments, a qualifying incident management event may comprise an event that indicates completion of an incident resolution process with respect to a particular incident. For example, a qualifying incident management event may describe an occurrence of one or more corrective action implementations for resolving the particular incident. In some embodiments, receiving the post-incident indication comprises determining occurrence of the qualifying incident management event.

In some embodiments, the post-incident indication is received from an external computing device associated with an enterprise application (e.g., one of the enterprise applications 104A-N). The post-incident indication may comprise an incident identifier associated with the incident. In some embodiments, the post-incident report generation server system 101 determines, based on the incident identifier, whether the incident satisfies post-incident report generation criteria. For example, the post-incident report generation server system 101 may be configured to automatically generate a post-incident report for an incident that satisfies the post-incident report generation criteria. In some embodiments, the post-incident report generation criteria comprise a severity level threshold. For example, the post-incident report generation server system 101 may be configured to automatically initiate a post-incident report generation process for each incident of a plurality of incidents associated with a severity level that satisfies the severity level threshold. In some embodiments, the post-incident report generation server system 101 is configured to initiate a post-incident report generation process for each incident of a plurality of incidents regardless of the severity level associated with each incident.

Alternatively or additionally, in some embodiments, the post-incident report generation server system 101 receives a post-incident report request. The post-incident report request may comprise an incident identifier associated with an incident and may be indicative of a request to generate a post-incident report for the incident. As described above, in some embodiments, the post-incident report request may be generated in response to user engagement with a post-incident report interface. For example, the post-incident report generation server system 101 may receive the post-incident report request from a client computing device (e.g., one of the client computing devices 102A-N) in response to user engagement with the post-incident report interface. For example, the client computing device may be associated with a user (e.g., alert manager, team member, team manager, and/or the like).

In some embodiments, the post-incident report generation server system 101, using one or more machine learning models 124 and/or one or more techniques, determines, extracts, and/or infers from one or more data sources associated with the one or more enterprise applications 104A-N, relevant post-incident data. For example, the one or more enterprise applications 104A-N may generate, store, and/or maintain various data, including, for example, incident data, alert data, and/or communication data associated with incidents. In some embodiments, relevant post-incident data may describe data/information associated with an incident that is deemed to be relevant for inclusion in a post-incident report and/or deemed relevant for generating a post-incident report. Examples of relevant post-incident data may include incident summary data, incident timeline data, root cause data, fault data (e.g., faulty service), fault propagation path data, blast radius data, and/or the like.

The one or more machine learning models may include one or more natural language processing (NLP) models, generative artificial intelligence, and/or the like. In some embodiments, the one or more machine learning models include one or more of BiLSTM-CRF models, LSTM models, hidden Markov models, learning-to-rank models, and/or the like. The one or more machine learning models may comprise one or more machine learning models, trained, configured, and/or the like to determine, extract, and/or infer the relevant post-incident data. For example, the one or more machine learning models may be trained, configured, and/or the like to determine, extract, and/or process incident data, alert data, communication data and/or other incident-related data maintained or otherwise stored by the one or more data sources (e.g., one or more enterprise applications 104A-N) to determine, extract, and/or infer relevant post-incident data associated with the incident.

The one or more machine learning models may be trained on training data comprising incident data, alert data, communication data, and/or other incident-related data associated with a plurality of historical incidents. For example, one or more machine learning models may be trained using training dataset that includes historical incident data, alert data. and/or communication data. In some embodiments, the training data may include linkages to the one or more enterprise applications 104A-N. One or more machine learning models may be trained, configured, and/or the like to correlate data from the one or more data sources to infer the relevant post-incident data or portions thereof. For example, the post-incident report generation server system 101, using the one or more machine learning models (e.g., including generative artificial intelligence), may be configured to generate inferences (e.g., using causal inference technique(s) and/or the like) based on data/information accessed from the one or more data sources. In some embodiments, the post-incident report generation server system 101 may leverage a causal inference technique to generate inferences and correlate the inferences with topology information to determine one or more portions of the relevant post-incident data (e.g., corrective actions, root cause, and/or the like) for the incident associated with the incident identifier.

In one example embodiment, the post-incident report generation server system 101 leverages a BILSTM-CRF model (e.g., based on BILSTM-CRF sequence labeling technique) to determine one or more portions of the relevant post-incident data for an incident. By way of example, the BILSTM-CRF model and/or other machine learning models may be trained, configured, and/or the like to correlate corrective action data extracted and/or inferred from communication data from one or more communication channels (e.g., Slack, Microsoft Teams, and/or the like) with incident data (e.g., data from issue data objects, and/or the like) to determine relevant corrective actions to include in the post-incident report. For example, the post-incident report generation server system 101, using a BILSTM-CRF model and/or other machine learning models may process communication data retrieved from an enterprise application configured to provide collaboration services (e.g., Slack, Microsoft Teams, and/or the like) to generate candidate relevant post-incident data. For example, the BILSTM-CRF model may receive, as input, communication features extracted from communication data and process the communication data to output candidate relevant post-incident data comprising corrective actions discussed or otherwise mentioned in the communication channel. In some embodiments, the post-incident report generation server system 101, correlates the candidate relevant post-incident data with other data extracted from the one or more enterprise applications and/or topological information to determine the relevant post-incident data for the incident. For example, as described above, the post-incident report generation server system 101 may correlate corrective action data extracted from the communications data with comment data from issue data objects (e.g., problem tickets) to identify relevant corrective action data to include in the post-incident report. In this regard, in some embodiments, the post-incident report generation server system 101, using the one or more machine learning models, may be configured to correlate data maintained by one or more data sources associated with the one or more enterprise applications 104A-N to determine relevant post-incident data for inclusion in a post-incident report or for generating a post-incident report for an incident.

As illustrated in FIG. 4, incident data 402, alert data 404, and communication data 406 may be received in response to a post-incident indication or post-incident report request. In some embodiments, the incident data 402 comprise incident title data, incident description data, and/or incident comments. Additionally the incident data 402 may comprise data from issue data objects (e.g., problem tickets) associated with the incident. In some embodiments, alert data 404 comprise data from alerts associated or otherwise linked to the incident. In some embodiments, communication data 406 comprise data from communication channels (e.g., Slack, Teams, and/or the like) associated with the incident. For example, one or more communication channels may be opened in response to an incident to enable communication between various parties (e.g., team members, team manager, stakeholders, and/or the like) associated with the incident and/or tasked to resolve the fault(s) associated with the incident.

As shown in FIG. 4, the post-incident report generation server system 101 (e.g., using a feature extraction unit 113 thereof) extracts one or more incident features 408 from the incident data 402. Alternatively or additionally, the post-incident report generation server system 101 (e.g., using a feature extraction unit 113 thereof) extracts one or more alert features 410 from the alert data 404. Alternatively or additionally, the post-incident report generation server system 101 (e.g., using a feature extraction unit 113 thereof) extracts one or more communication features 412 from the communication data 406.

In some embodiments, the post-incident report generation server system 101 utilizing, one or more machine learning models identifies and extracts corrective action data 414 from the communication data based on the communication features 412. The corrective action data, for example, may include corrective actions recommended and/or proposed (e.g., by team members assigned to the incident) within a communication channel (e.g., Slack, Teams, and/or the like) hosted by an enterprise application. In some embodiments, the one or more machine learning models comprise a sequence labeling model 413 such as a BILSTM-CRF model. In some embodiments, the BILSTM-CRF model is trained with labeled sequences using BIO encoding. The sequence labeling model 413 may receive (e.g., from a sequence labeling unit 114 of the post-incident report generation server system 101) the communication features 412 as input and process the communication features 412 to output corrective action data embedded with thin the communication data 406. In some embodiments, a sentence parser may be utilized to identify and/or extract the corrective action data 414. A non-limiting example of a parser that may be leveraged by the sequence labeling unit 114 includes an English Slot Grammar (ESG) parser.

In some embodiments, a deduplication operation may be performed with respect to the corrective action data 414 and/or second corrective action data 416 extracted from other data such as the incident data 402. By way of example, a first corrective action data item from communication data 406 may be the same as a second corrective action data item from incident data 402. In such example, a deduplication unit 115 of the post-incident report generation server system 101 may be configured to deduplicate the first corrective action data item and the second corrective action data item.

As shown in FIG. 4, the post-incident report generation server system 101 (e.g., aggregation unit 116 thereof) may aggregate the deduplicated corrective action data 417. In some embodiments, aggregating the deduplicated corrective action data 417 comprises compiling and/or ranking each corrective action data item. A corrective action data item may describe a particular corrective action. In some embodiments, the post-incident report generation server system 101 (e.g., aggregation unit 116 thereof) utilizing a ranking model 418, such as a learning-to-rank model, ranks the deduplicated corrective action data 417 based at least in part on user input (e.g., customer feedback). In this regard, some example embodiments provide for user-customization of a post-incident report.

In some embodiments, the post-incident report generation server system 101 (e.g., the inference unit 117 thereof) may be configured to execute or cause execution of one or more inference operations based on the incident data and/or alert data. In some embodiments, the output of the one or more inference operations comprises root cause data 423 (e.g., including a root cause of the incident), fault data 424 (e.g., e.g., including fault location/faulty service, fault propagation path data, and/or blast radius data associated with the incident). In some embodiments, the inference unit 117 leverages a graph centrality-based technique to generate the fault data 424 based on the incident features 408 extracted from incident data 402 and/or alert features 410 extracted from alert data 404. The post-incident report generation server system 101 (e.g., the inference unit 117 thereof) may leverage topology data 411 (e.g., configuration management database (CMDB), causal graph, service dependency graphs, and/or the like) to determine the fault location/faulty service. A CDMB may describe relationships between hardware, software, and/or networks utilized by an organization, such as an IT organization. A CDMB may store information on the configuration of items like hardware, software, systems, facilities, and/or the like. In some examples, the configuration data may include interdependencies between items, change history with respect to the items, and/or the like.

In some embodiments, the inference unit 117 may leverage graph centrality-based technique to determine the blast radius for the incident. The post-incident report generation server system 101 (e.g., the inference unit 117 thereof) may be configured to execute or cause execution of one or more inference operations to output a root cause of the faulty service that triggered the incident. Additionally, in some embodiments, post-incident report generation server system 101 (e.g., the inference unit 117 thereof) may be configured to execute or cause execution of one or more inference operations to output a root cause for incident-related services. As described above, incident-related services as used herein may describe other services affected by the incident.

As shown in FIG. 4, in some embodiments, the post-incident report generation server system 101 (e.g., post-incident report unit 112 thereof), utilizing one or more machine learning models comprising generative artificial intelligence 420 (e.g., OPenAI API, LLM API, and/or the like, generates incident summary data 422 based on the one or more incident features 408 and/or alert features 410. As shown in FIG. 4, the post-incident report generation server system 101 (e.g., post-incident report unit 112 thereof) may leverage the one or more machine learning models comprising the generative artificial intelligence 420 to generate a post-incident report 430 based on the incident summary data, 422, root cause data 423, fault data 424, timeline data, and deduplicated (and/or ranked) corrective action data 417.

In some embodiments, the post-incident report generation server system 101 transmits the post-incident report 430 for display on one or more client computing devices 102A-N. In some embodiments, the post-incident report 430 is rendered for display on a post-incident report user interface. In some embodiments, the post-incident report includes at least, a summary segment, a timeline segment, a root cause segment, and a corrective action segment The summary segment may describe a summary of the incident. The timeline segment may describe a sequence of events associated with the incident. In some embodiments, the timeline segment includes sequence of events that led to the incident. The root cause segment may include the root cause of the faulty service and/or other services affected by the incident. The corrective action segment may include recommended corrective actions and/or corrective actions implemented to resolve the fault associated with the incident. In some embodiments, the post-incident report includes other data such as the impact of the incident, when the incident was detected, response to the incident, how the incident was resolved, and/or the like.

Having described example systems, apparatuses, and data visualizations, in accordance with the disclosure, example processes of the disclosure will now be discussed. It will be appreciated that each of the flowchart(s) depicts an example computer-implemented process that is performable by one or more of the apparatuses, systems, devices, and/or computer storage media described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

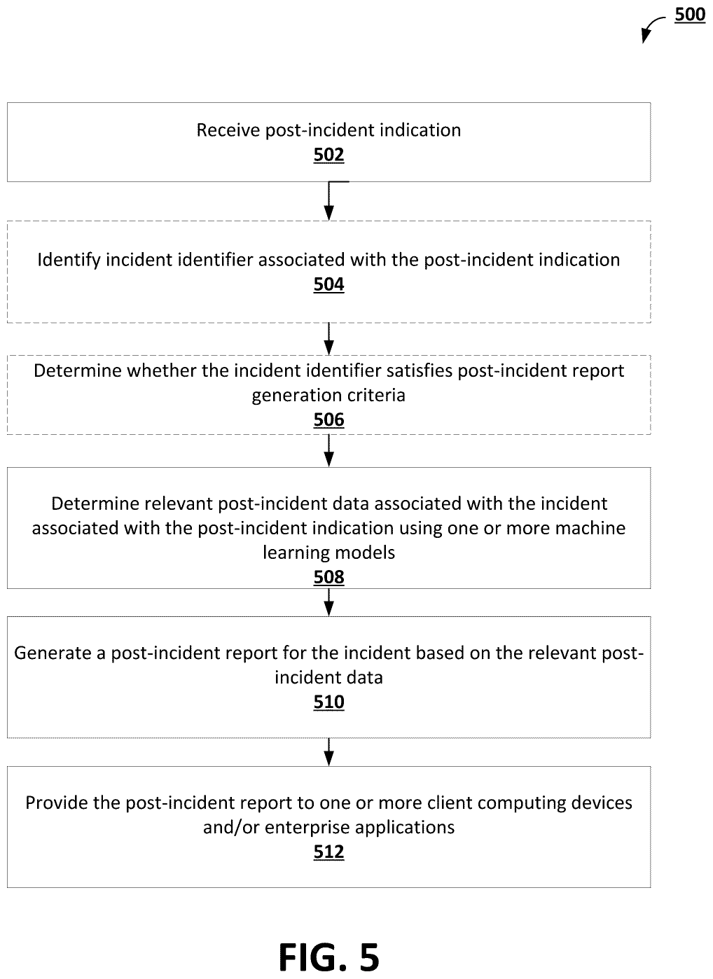

FIG. 5 illustrates a flow chart depicting example operations of an example process 500 for performing operations that are configured to generate post-incident reports, in accordance with at least one embodiment of the present disclosure. In some embodiments, the process 500 is embodied by computer program code stored on a non-transitory computer-readable storage medium of a computer program product configured for execution to perform the process as depicted and described. Alternatively or additionally, in some embodiments, the process 500 is performed by one or more specially-configured computing devices, such as the apparatus 200 alone or in communication with one or more other component(s), device(s), system(s), and/or the like. In this regard, in some such embodiments, the apparatus 200 is specially-configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one external data repository, client system, and/or the like, to perform one or more of the operations as depicted and described. For purposes of simplifying the description, the process 500 is described as performed by and from the perspective of the apparatus 200.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

Via the various operations of the process 500, the apparatus 200 can generate a post-incident report for an incident after occurrence of the incident, such that the post incident report includes relevant post-incident data associated with the incident. According to some examples, the method includes receiving a post-incident indication associated with an incident identifier at block 502.

In some embodiments, the apparatus 200 embodying the post-incident report generation server system receives the post-incident indication from an enterprise application. For example, an external computing device associated with an enterprise application may transmit a signal corresponding to a post-incident indication in response to a qualifying incident management event associated with the incident. As described above, in some embodiments, a qualifying incident management event may indicate completion of certain action(s) associated with an incident resolution process for resolving the incident. Alternatively or additionally, in some embodiments, receiving a post-incident indication comprises identifying a qualifying incident management event (as described above). For example, the apparatus 200 may be configured to monitor one or more enterprise applications to determine the occurrence of a qualifying incident management event.

According to some examples, the method includes, identifying the incident identifier associated with the post-incident indication at block 504. As described above, each incident may be associated with an incident identifier configured to uniquely identify the incident from other incidents. In some embodiments, the apparatus 200 may leverage the incident identifier to determine whether to initiate generation of a post-incident report for the incident associated with the incident identifier. The block 506 may be an optional step/operation in some embodiments.

According to some examples, the method includes determining whether the incident identifier satisfies post-incident report generation criteria at block 506. In some embodiments, the apparatus 200 is configured to automatically initiate generation of a post-incident report for an incident associated with an incident identifier that satisfies the post-incident report generation criteria. In some embodiments, the post-incident report generation criteria comprise a severity level threshold. The block 506 may be an optional step/operation in some embodiments. In some embodiments, the apparatus 200 may be configured to initiate a post-incident report generation process in response to receiving a post-incident indication regardless of whether the incident identifier satisfies the post-incident generation criteria. In such examples, the apparatus 200 may not perform the operation of block 506 to determine whether the post-incident trigger satisfies any post-incident report criteria.

According to some examples, the method includes determining relevant post-incident data associated with the incident associated with the post-incident indication at block 508. For example, the apparatus 200 may determine, using an artificial intelligence framework and based on one or more enterprise applications, relevant post-incident data associated with the incident. As described above, relevant post-incident data may comprise data/information associated with an incident that is deemed to be relevant for inclusion in a post-incident report and/or deemed relevant for generating a post-incident report for the incident. In some embodiments, the apparatus 200 utilizes one or more machine learning models to identify the relevant post-incident data. In one example embodiment, the apparatus 200 utilizes an artificial intelligent framework comprising one or more machine learning models, trained, configured, and/or the like to determine relevant post-incident data from one or more data sources associated with one or more enterprise applications. For example, the apparatus 200 may utilize one or more machine learning models trained, configured, and/or the like to determine and extract incident data, alert data, and/or other incident-related data maintained or otherwise stored by the one or more data sources (e.g., one or more enterprise applications) to determine relevant post-incident data associated with the incident.

In some embodiments, the one or more machine learning models may be trained to correlate data from the one or more data sources to infer the relevant post-incident data or portions thereof. For example, the apparatus 200, using the one or more machine learning models, may be configured to generate inferences based on data/information accessed from the one or more data sources. For example, the apparatus 200 may determine the relevant post-incident data for the incident, where one or more portions of the relevant post-incident data comprise inferred data outputted by the one or more machine learning models based on a causal inference technique.

In one example embodiment, the apparatus 200 leverages a BILSTM-CRF model (e.g., based on BILSTM-CRF sequence labeling technique) to determine one or more portions of the relevant post-incident data for an incident. In some embodiments, the BILSTM-CRF model and/or other machine learning models may be trained, configured, and/or the like to correlate particular type of data/information associated with an incident with other type(s) of data/information associated with the incident to determine at least a portion of the relevant post-incident data for the incident. In some embodiments, the BILSTM-CRF model and/or the one or more machine learning model may be configured to output candidate relevant post-incident data. For example, the apparatus 200 may leverage a BILSTM-CRF machine learning model framework configured to output candidate relevant post-incident data. In some embodiments, the apparatus 200 correlates the candidate relevant post-incident data with other data extracted from the one or more enterprise applications and/or topological information to determine the relevant post-incident data for the incident and/or portions of the relevant post-incident data.

As a non-limiting example, the apparatus 200, using the BILSTM-CRF model and/or other machine learning models may determine candidate corrective action data/information associated with the incident based on one or more data sources. For example, the apparatus 200, using the BILSTM-CRF model and/or other machine learning models may process communication data from one or more communication channels (e.g., Slack, Microsoft Teams, and/or the like) associated with the incident to determine the candidate corrective action data/information. The candidate corrective action data/information, for example, may comprise all corrective actions mentioned in the communication channel(s) thread. In this regard, one or more of the candidate corrective actions may comprise relevant corrective actions while others may not. For example, a subset (e.g., some, all) of the candidate corrective actions may comprise actual corrective actions implemented to resolve the incident and deemed as relevant post-incident. The apparatus 200 may correlate the candidate corrective actions with incident comments and/or other data (e.g., from the communication channels and/or other data sources) to determine the relevant corrective actions of the candidate corrective actions. In this regard, the relevant corrective actions may comprise a portion of the relevant post-incident data for the incident. In one example embodiment, the one or more machine learning models comprise a learning-to-rank model configured to rank data from the various data sources. For example, the apparatus 200, utilizing a learning-to-rank model may rank and/or prioritize information from various sources based on user input (e.g., user feedback). In this regard, the learning-to-rank model may be leveraged to enable customization of a post-incident report based on user feedback.

In some embodiments, the one or more machine learning models are previously trained based on historical data comprising historical incident data and historical alert data. For example, continuing with the corrective action example, the historical data may include historical communication channel data, and/or historical data retrieved from one or more other data sources associated with the one or more enterprise applications.

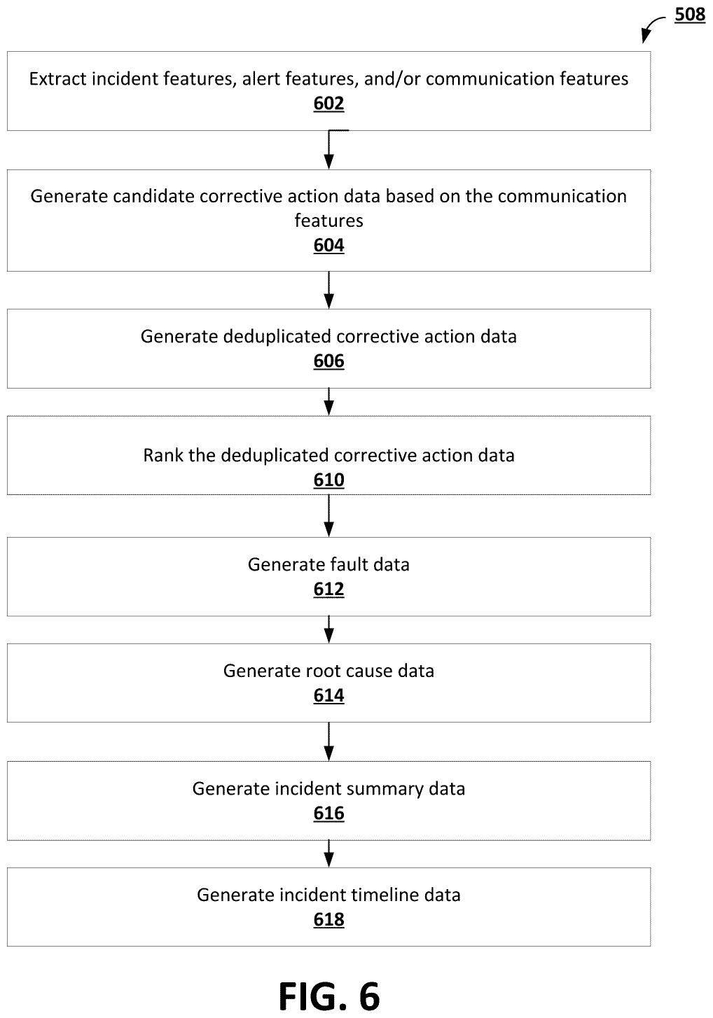

In some embodiments, the operations/process that is depicted at block 508 may be performed in accordance with the example process 600 depicted in FIG. 6. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to some examples, the method includes extracting one or more incident features, one or more alert features, and/or one or more communication features at block 602. For example, the apparatus 200 may extract one or more incident features from incident data associated with the incident. In some embodiments, the incident data comprise incident title data, incident description data, and/or incident comments. The incident data may also comprise data from issue data objects (e.g., problem tickets) associated with the incident. Alternatively or additionally, the apparatus 200 may extract one or more alert features from alert data associated with the incident. In some embodiments, alert data comprise data from alerts associated with or otherwise linked to the incident. Alternatively or additionally, the apparatus 200 may extract one or more communication features from communication data associated with the incident. In some embodiments, the communication data comprise data from communication channels (e.g., Slack, Teams, and/or the like) associated with the incident. For example, as described above, one or more communication channels may be opened in response to an incident to enable communication between various parties (e.g., team members, team manager, stakeholders, and/or the like) associated with the incident and/or tasked to resolve the fault(s) associated with the incident.

According to some examples, the method includes generating candidate corrective action data based on the communication features at block 604. The candidate corrective action data may comprise corrective action data embedded within communication data associated with the incident). For example, the apparatus 200 may identify and extract candidate corrective action data embedded within the communication data, using a sequence labeling model, and based on the communication features extracted at block 602. As described above, the candidate corrective action data may include corrective actions recommended and/or proposed (e.g., by team members assigned to the incident) within a communication channel hosted by an enterprise application.

In some embodiments, sequence labeling model comprises a BILSTM-CRF model. In some embodiments, the BILSTM-CRF model is trained with labeled sequences using BIO encoding. The sequence labeling model (e.g., BILSTM-CRF model, and/or the like) may receive the communication features as input and process the communication features to output corrective action data (e.g., candidate corrective action data) embedded within communication data associated with the incident. In some embodiments, a sentence parser, such as English Slot Grammar (ESG) parser may be utilized to identify and/or extract the candidate corrective action data.

According to some examples, the method includes generating deduplicated corrective action data at block 606. For example, the apparatus 200 may execute or cause execution of a deduplication with respect to the candidate corrective data and/or other candidate corrective action data extracted from other data sources. For example, the apparatus 200 may perform a deduplication operation with respect to the corrective action data extracted from the communication data and corrective action data extracted from the incident data.

According to some examples, the method includes ranking the deduplicated corrective action data at block 610. For example, the apparatus 200 may aggregate and rank the deduplicated corrective action data using a ranking model. In some embodiments, the ranking model comprises a learning-to-rank model. For example, the apparatus 200, utilizing a ranking model (such as a learning to rank model) and based on user input (e.g., customer feedback) may assign a rank value to each individual corrective action data item. A corrective action data item may describe a particular corrective action. For example, the deduplicated corrective action data may comprise a plurality of corrective actions data items, where each corrective action data item represents a particular proposed, recommended, and/or implemented corrective action.

According to some examples, the method includes generating fault data at block 612. For example, the apparatus 200 may execute or cause execution of one or more inference operations based on the incident features and/or alert features to generate fault data. In some embodiments the fault data includes fault location/faulty service, fault propagation path data, and/or blast radius data associated with the incident. In some embodiments, apparatus 200 generates the fault data using a graph centrality-based technique based on the incident features (e.g., extracted from incident data) and/or alert features (e.g., extracted from alert data). In some embodiments, the apparatus 200 leverages topology data (e.g., CMDB, causal graph, service dependency graphs, and/or the like) to determine the fault location/faulty service. Additionally, in some embodiments, the apparatus 200 leverages a graph centrality-based technique to determine the blast radius for the incident. In some embodiments, to generate the fault location/faulty service (e.g., to localize the fault), the apparatus 200 generates a causal graph of services from alert data and/or topology data. The apparatus 200, using a graph centrality algorithm/model, may then identify the starting point. A graph centrality algorithm/model may be configured for determining the role and/or impact of particular node(s) of a graph, such as the causal graph of services. In this regard, the apparatus 200 may leverage a graph centrality algorithm/model to identify the fault location (e.g., origin of the fault) with respect to the services represented in the casual graph of services. In some embodiments, the apparatus 200 generates a fault propagation path using link prediction techniques and/or other techniques. For example, the apparatus 200 may generate a fault propagation path using a link prediction model. A link prediction technique/model may be configured to predicting the existence of a link between and among nodes of a graph, such as the causal graph of services. In this regard, the apparatus 200 may leverage a link prediction technique/model to identify the existence of a link between and among services represented in the causal graph of services with respect to a fault associated with the incident.

According to some examples, the method includes generating root cause data at block 614. For example, the apparatus 200 may execute or cause execution of one or more inference operations based on the incident features and/or alert features to generate root cause data. The root cause data may comprise a root cause of the fault associated with the incident. For example, the apparatus 200 may execute or cause execution of one or more inference operations to output a root cause of the faulty service that triggered the incident. Additionally, the apparatus 200 may be configured to execute or cause execution of one or more inference operations to output a root cause for incident-related services. As described above, incident-related services as used herein may describe other services affected by the incident.

According to some examples, the method includes generating incident summary data at block 616. For example, the apparatus, utilizing one or more machine learning models generates incident summary data 422 based on the one or more incident features and/or one or more alert features. In some embodiments, the one or more machine learning models comprise generative artificial intelligence such as, OPenAI API, LLM API, and/or the like.

According to some examples, the method includes generating incident timeline data at block 618. For example, the apparatus 200 may generate the incident timeline data based on the incident data (e.g., at least a portion of the incident data) and/or alert data. For example, the apparatus 200 may generate the incident timeline data based on description data and/or comment data extracted from the incident data object (e.g., incident ticket) and/or associated alerts. The timeline data may include the root cause of the fault and services affected by the incident. For example, the apparatus 200 may generate incident timeline data that includes the fault data and root cause data generated in blocks 612 and 614, respectively.

Returning to FIG. 5, according to some examples, the method includes generating a post-incident report for the incident based on the relevant post-incident data at block 510. For example, the apparatus, utilizing one or more machine learning models generates a post-incident report based on the incident summary data, root cause data, corrective action, deduplicated (and/or ranked) corrective action data, and/or incident timeline data. In some embodiments, the one or more machine learning models comprise generative artificial intelligence such as, OPenAI API, LLM API, and/or the like. In some embodiments, the post-incident report includes incident summary segment, incident timeline segment, root cause segment and/or a corrective action segment. In some embodiments, the summary segment may describe a summary of the incident. The timeline segment may describe a sequence of events associated with the incident (e.g., when the incident was detected, response to the incident, and/or the like). In some embodiments, the timeline segment includes sequence of events that led to the incident. The root cause segment may include the root cause of the fault, services affected by the incident, and/or impact data (e.g., impact of the incident). The corrective action segment may include recommended corrective actions and/or corrective actions implemented to resolve the fault associated with the incident. In some embodiments, the apparatus 200, utilizing the one or more machine learning models, may generate the post-incident report for the incident in accordance with a predefined post-incident report template.

According to some examples, the method includes providing the post-incident report to one or more client computing devices and/or enterprise applications at block 512. In some embodiments, the apparatus 200 may render the post-incident report for display on a pos-incident report user interface. In some embodiments, the apparatus 200 may be configured to generate the post-incident report user interface for rendering on a client computing device and/or enterprise application.

Alternatively or additionally, in some embodiments, the apparatus 200 is configured to perform one or more of the operations depicted in FIG. 5 in response to a post-incident report request. For example, in some embodiments, the method may include performing the step/operations of blocks 504-512 in response to receiving a post-incident report request.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### Conclusion

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and at least one memory including program code, the at least one memory and the program code configured to, with the at least one processor, cause the apparatus to at least:
in response to a qualifying incident management event associated with an incident, identify one or more enterprise applications comprising data associated with the incident;
extract, from the one or more enterprise applications, one or more data features;
generate, based on the one or more data features and using one or more machine learning models, post-incident data associated with the incident; and
initiate performance of one or more incident management actions using a generative artificial intelligence model and based on the post-incident data.

2. The apparatus of claim 1, wherein initiating performance of the one or more incident management actions comprises:
generating, based on the post-incident data and using the generative artificial intelligence model, a post-incident report for the incident.

3. The apparatus of claim 2, wherein initiating performance of the one or more incident management actions further comprise:
transmitting the post-incident report to an enterprise application of the one or more enterprise applications.

4. The apparatus of claim 2, wherein initiating performance of one or more incident management actions further comprise:
transmitting one or more computer-executable instructions configured to cause rendering of a post-incident report interface on a client computing device, wherein the post-incident report interface comprises the post-incident report.

5. The apparatus of claim 1, wherein the one or more data features comprise alert features, wherein extracting the one or more data features comprises:
identifying alert data maintained via at least one enterprise application of the one or more enterprise applications;
generating one or more vector representations corresponding to the alert data; and
inputting the one or more vector representations into a machine learning model configured to generate the alert features based on the one or more vector representations.

6. The apparatus of claim 1, wherein the one or more data features comprise one or more of (i) incident features, (ii) alert features, or (iii) communication features extracted from one or more communication channels generated via at least one enterprise application of the one or more enterprise applications.

7. The apparatus of claim 1, wherein the post-incident data comprises fault data that identifies a faulty service of one or more services.

8. The apparatus of claim 7, wherein the post-incident data further comprise root cause data for the incident, wherein generating the post-incident data comprises:
performing one or more inference operations to generate the root cause data based on one or more of alert features or incident features from the one or more data features.

9. A computer-implemented method, comprising:
identifying an incident identifier that satisfies post-incident report generation criteria;
extracting, from one or more data sources, one or more data features associated with an incident corresponding to the incident identifier;
generating a post-incident report based on the one or more data features and using one or more machine learning models; and
transmitting one or more computer-executable instructions configured to cause rendering of the post-incident report on a post-incident report user interface.

10. The computer-implemented method of claim 9, wherein the one or more data sources correspond to one or more enterprise applications.

11. The computer-implemented method of claim 10, wherein the one or more data features comprise alert features, wherein extracting the one or more data features comprises:
identifying alert data maintained via at least one enterprise application of the one or more enterprise applications;
generating one or more vector representations of the alert data; and
inputting the one or more vector representations of the alert data into a machine learning model configured to generate the alert features based on the one or more vector representations.

12. The computer-implemented method of claim 10, wherein the one or more data features comprise incident features, wherein extracting the one or more data features comprises:
identifying incident data maintained via at least one enterprise application of the one or more enterprise applications;
generating one or more vector representations corresponding to the incident data; and
inputting the one or more vector representations into a machine learning model configured to generate the incident features based on the one or more vector representations.

13. The computer-implemented method of claim 10, wherein the one or more data features comprise communication features, wherein extracting the one or more data features comprises:
identifying communication data maintained via at least one enterprise application of the one or more enterprise applications;
generating one or more vector representations corresponding to the communication data; and
inputting the one or more vector representations into a machine learning model configured to generate the communication features based on the one or more vector representations.

14. The computer-implemented method of claim 9, wherein generating the post-incident report based on the one or more data features comprises:
generating post-incident data based on the one or more data features; and
generating the post-incident report using a generative artificial intelligence model and based on the one or more data features.

15. The computer-implemented method of claim 14, wherein the post-incident data comprises fault data that identifies a faulty service of one or more services.

16. The computer-implemented method of claim 14, wherein the post-incident data comprise root cause data for the incident, wherein generating the post-incident data comprises:
performing one or more inference operations based on alert features and incident features from the one or more data features to generate the root cause data.

17. At least one non-transitory computer-readable storage medium for generating post-incident reports, the at least one non-transitory computer-readable storage medium having computer coded instructions configured to, when executed by at least one processor:
receive a post-incident report request via a post-incident report interface, wherein the post-incident report request comprises an incident identifier;
extract, from one or more data sources and based on the incident identifier, one or more data features;
generate, based on the one or more data features and using one or more machine learning models, post-incident data associated with the incident identifier; and
initiate performance of one or more incident management actions using a generative artificial intelligence model and based on the post-incident data.

18. The at least one non-transitory computer-readable storage medium of claim 17, wherein initiating performance of the one or more incident management actions comprises:
generating, based on the post-incident data and using a generative artificial intelligence model, a post-incident report.

19. The at least one non-transitory computer-readable storage medium of claim 18, wherein initiating performance of the one or more incident management actions further comprise:
transmitting the post-incident report to one or more enterprise applications.

20. The at least one non-transitory computer-readable storage medium of claim 18, wherein initiating the performance of the one or more incident management actions further comprise:
transmitting one or more computer-executable instructions configured to cause rendering of a post-incident report interface on a client computing device, wherein the post-incident report interface comprises the post-incident report.
